(19) United States
(12) Patent Application Publication
(10) Pub. No.: US 2013/0345340 A1
(43) Pub. Date: Dec. 26, 2013

(54) Composition for the Optimization of Mineral Building Material Compositions

(71) Applicants: Ralph Scheuermann, Essen (DE); Frank Koenig, Gelsenkirchen (DE); Andreas Vetter, Essen (DE); Jörn Heissing, Essen (DE); Markus Roos, Essen (DE)

(72) Inventors: Ralph Scheuermann, Essen (DE); Frank Koenig, Gelsenkirchen (DE); Andreas Vetter, Essen (DE); Jörn Heissing, Essen (DE); Markus Roos, Essen (DE)

(73) Assignee: Evonik Degussa GmbH, Essen (DE)

(21) Appl. No.: 14/003,880

(22) PCT Filed: Mar. 7, 2012
(86) PCT No.: PCT/EP2012/053833

§ 371 Date: Sep. 9, 2013

(30) Foreign Application Priority Data
Mar. 14, 2011 (DE) 102011005484.7

(51) Int. Cl. C04B 24/42; C04B 24/02; C04B 24/12

(52) U.S. Cl. CPC C04B 24/42; C04B 24/123; C04B 24/023
USPC 524/3; 524/588; 524/238; 524/431; 524/376

(57) ABSTRACT

The present invention relates to compositions which are suitable for optimizing mineral building material compositions so that the flow behaviour and the deaeration of the compositions is positively influenced, as a result of which very smooth, virtually pore-free surfaces can be achieved. The compositions can consist of a mixture or comprise a mixture which contains at least one component (a) which comprises a compound N which displays a wetting action in aqueous cement-containing binder systems and contains at least one further component (b) which comprises a compound E which has antifoam properties in aqueous cement-containing binder systems. The compound N in component a) can preferably be a nonionic or amphoteric surfactant, preferably an alkyl alkoxylate or a betaine. The compound E in component b) can preferably be a polyetherpolysiloxane on a support material.

The present application claims priority from PCT Patent Application No. PCT/EP2012/053833 filed on Mar. 7, 2012, which claims priority from German Patent Application No. DE 10 2011 005 484.7 filed on Mar. 14, 2011, the disclosures of which are incorporated herein by reference in their entirety.

### FIELD OF THE INVENTION

The present invention provides compositions suitable for optimizing mineral construction compounds in such a way as to positively influence in particular the flow characteristics and the removal of air from the compounds, thereby allowing very smooth, virtually pore-free surfaces to be obtained.

It is noted that citation or identification of any document in this application is not an admission that such document is available as prior art to the present invention.

The presently available mineral construction compounds are required continually to produce comparable outcomes under application conditions, and also to be easy to prepare and to use. Among the mineral construction compounds, particular importance attaches to fluid compounds such as screeds and self-levelling systems, including the self-levelling flooring compounds known as self-levelling underlayments (SLUs), which are therefore required to have particular properties: they must be able to flow out easily, in order to compensate unevennesses in the floor, while retaining good processing qualities; after flowing out, they must cure to a firm and highly robust layer which has good load-bearing capacity and resistance to wear and abrasion; and at the same time must have a surface which, while being extremely smooth, continues to have good adhesion properties, in order to allow an overlay to be applied reliably and durably to the floor levelling compound.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of, any previously described product, method of making the product, or process of using the product.

In old buildings in particular, floors often show severe wear from usage. Over time, these floors become not only unattractive, but also uneven. Old wooden floorboards, for example, have often been worn down to such an extent by foot traffic that they can no longer be renovated. If the substrate, although uneven, nevertheless still has sufficient load-bearing capacity, it is sufficient to apply a self-levelling underlayment. On concrete floors or old tiles, this is a simple matter. There, the compound can be poured out directly. Even wooden floors, however, may be straightened using a compound of this kind. Unevennesses of up to several centimetres are not uncommon. In view of the uneven thicknesses of the resulting layer of levelling compound, no loss of volume on setting is desirable, in order to avoid possible repetitions of the levelling operation. With new buildings as well, however, the role of self-levelling systems is continually increasing, particularly over large areas such as enclosed car parks or factory halls, for example.

Both in renovation and on scheduled construction sites, a short construction time is playing an ever-greater part—whether in order to comply with completion deadlines or to re-establish quick foot-traffic accessibility to the levelled floor areas, for conventional usage. After just a few hours, the floor is to be accessible to foot traffic again and to be suitable for laying with tiles, natural stone, PVC or carpeting, for example.

During processing, floor levelling compounds having good flowout properties and long flowout open time are desirable. By this means it is to be possible to achieve very level surfaces without great outlay. A low air content in the fresh compound, and especially in the cured compound, is highly relevant for the load-bearing and abrasion-resistance qualities. A homogeneous, crater-free and bubble-free surface is very important not only on aesthetic grounds but also, more particularly, for the mechanical properties.

The desire is therefore for construction compositions which have preferably the following properties:
high fluidity, characterized by the slump
no adverse effect on processing life (open time), and therefore, depending on the application, quick hardening and early walkability and overlayability
non-shrinking
machine-appliable.

Mineral construction compounds and their importance are known to the skilled person and are widely described in the literature, as for example by Leopolder, ZKG International, 32 in No. 4 (2010) or Schumacher M. in Baustoffpraxis, 22, volume 12 (2009).

In the past there have been a variety of approaches at improving the properties of mineral construction compounds of this kind.

FR 2943665 A1 describes mineral floor levelling compounds comprising 10% to 50% by weight of ettringite and 50% to 90% by weight of aggregates, of which at least 30% by weight are synthetic inorganic aluminocalcites.

EP 0934915 A1 describes self-levelling, particularly high-performance concrete and its production. For its production, per 100 parts of cement, 0.1 to 10 parts of a defoaming agent are added, and 0.1 to 10 parts of a superplasticizing and water-reducing agent. Defoaming agents used are preferably silicates, which have been treated with polymerized glycol, or mixtures of dodecyl alcohol and polypropylene glycol, and silicates modified accordingly.

### SUMMARY OF THE INVENTION

It was an object of the present invention to provide compositions which when used in mineral construction compounds, more particularly mineral floor levelling compounds, preferably exhibit better flow properties, a better surface quality, and a low air content, and which are easy to prepare and to apply.

Surprisingly it has been found that mineral construction compounds which comprise the compositions of the invention meet the object identified above.

Accordingly it is possible to improve the in-use properties of mineral construction compounds, more particularly mineral floor levelling compounds, and to reduce the air content.

The compositions of the invention and the mineral construction compounds comprising them have the advantage that the use thereof produces an improvement in relation to surface quality and/or air content and hence also compressive strength and/or abrasion resistance, and also in the flow properties prior to curing.

A further advantage of the composition of the invention lies in the diverse possibilities for use, which are virtually independent of the other constituents of the mineral construction compounds.

### DETAILED DESCRIPTION OF EMBODIMENTS

The invention accordingly provides compositions which may consist of a mixture or may comprise a mixture which contains at least one component which (a) comprises a compound N which exhibits wetting activity in aqueous cementitious binder systems, and which (b) comprises at least one further component which comprises a compound E which exhibits defoaming properties in aqueous cementitious binder systems, the compound E being different from the compound N, where the mass ratio of compound N to compound E is from 0.001:1 to 1000:1, preferably 0.01:1 to 100:1, more preferably 0.1:1 to 10:1 and very preferably 0.15:1 to 7:1.

The composition may be present as a solid at a temperature of 25° C. The composition of the invention is preferably characterized in that the compound N of component a) and/or the compound E of component b) are/is present as a solid at a temperature of 25° C.

A further subject of the invention is that component a) and/or component b) of the composition may consist exclusively of the respective compound N or of the respective compound E.

In another embodiment of the invention, the compositions, the components a) and/or b), and the compounds N or E themselves may be present applied to a carrier, absorbed, encapsulated or adsorbed on or mixed with a carrier material, the carrier material being selectable from inorganic or organic materials or mixtures thereof, preferably silicas, aluminium oxide, sand, cement, flyash, bentonites, xonotlites or lime or starch, cellulose, wood granules or proteins, plastics pellets; from the standpoint of cost, inorganic carrier materials are used with particular preference. Where at least one of the components is a solid itself at 25° C., the respective other component may be applied to the first itself or may be in carried, absorbed or adsorbed form, or, where both components are solids at 25° C., they may simply be physically mixed.

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

The mass fraction of the compounds N or of the compounds E, based on the sum of the masses of the compounds N and/or compounds E and of the carrier materials in the respective components a) and/or b), may be from 0.001% to 50% by weight, preferably 0.01% to 30% by weight, more preferably 0.1% to 20% by weight, very preferably 1% to 10% by weight.

The mass fraction of the compounds which are liquid at 25° C., based on the sum of those fractions of the composition that are solid at 25° C., consisting of the compounds N and E, and also the carrier material, may be from 0.002% to 60% by weight, preferably 0.02% to 35% by weight, more preferably 0.05% to 25% by weight, very preferably 0.5% to 12% by weight.

In one particular embodiment of the invention, the composition of the invention may comprise at least one compound N in component a) which represents a nonionic or amphoteric surfactant. The nonionic or amphoteric surfactant may preferably be an alkyl alkoxylate or a betaine, more preferably a betaine, which may be liquid or solid, and more particularly a betaine which is present as a solid at a temperature of 25° C.

The compound E in component b) of the composition of the invention may preferably be a polyetherpolysiloxane, in which case the polyetherpolysiloxane may be applied on a carrier material, preferably an inorganic carrier material, more preferably fly ash.

Component a) of the composition of the invention may be a betaine present as a solid at a temperature of 25° C., component b) may consist of an optionally liquid polyetherpolysiloxane applied to flyash as carrier material, where the fraction of the compound E in component b) is from 1% to 10% by weight, and the mass ratio of component a) to component b) is from 1:10 000 to 1:1, preferably 1:1000 to 1:10 and more preferably 1:500 to 1:20.

The composition of the invention may, besides the mixture containing components a) and b), comprise further additions, and the mass fraction of the sum of components a) and b) may be from 0.001% to 10% by weight, preferably from 0.01% to 5% by weight and more preferably from 0.05% to 1% by weight, based on the mass of the overall composition.

These further additions may be selected from water, binding agents or binders, preferably port land cement and/or alumina cement, fillers, preferably calcium sulphate, its hydrates, silica sand and/or finely ground limestone, additives, preferably redispersible powders, setting accelerators, preferably lithium carbonate, setting retarders, preferably citric acid, shrinkage reducers, plasticizers and superplasticizers.

In a further embodiment of the invention, the composition of the invention may, besides the mixture containing components a) and b), comprise further additions, with a further component possibly being portland cement, gypsum and/or alumina cement or mixtures thereof.

The compositions of the invention may be used as mineral construction compounds, or at least as a constituent of mineral construction compounds, preferably self-levelling mineral underlayments or in self-levelling mineral flooring compounds.

The mineral construction compound in question may also be mixed with organic binders or binding agents.

The invention further provides a method for producing a mineral construction compound, in which a composition of the invention is mixed with water and binders, preferably portland cement, gypsum and/or alumina cement, and optionally one or more further components, selected from fillers, preferably calcium sulphate, its hydrates, silica sand and/or finely ground limestone, additives, preferably redispersible powders, setting accelerators, preferably lithium carbonate, setting retarders, preferably citric acid, shrinkage reducers, plasticizers and superplasticizers.

The compositions of the invention can be used in mineral construction compounds for producing floors which are preferably self-levelling.

As compound E of component b) it is possible more particularly to use those compounds selected from finely divided, hydrophobic solids and oils which are insoluble in water under application conditions. To improve their activity, the oils may comprise finely divided, hydrophobic particles. Such hydrophobic solids, oils or dispersions of particles in oils can be modified by blending with additives (e.g. emulsifiers) in such a way that they are easy to emulsify, with little shearing, in aqueous applications. Optionally these oils or dispersions may also be formulated directly into aqueous emulsions, in which case customary additives (emulsifiers, thickeners, protective colloids, preservatives) and homogenizing techniques for emulsion preparation may be used.

Examples of hydrophobic oils which may be used as compound E are mineral oils (A), vegetable oils (B), silicone oils (C), polyoxyalkylenes (D), modified polysiloxanes (P), and also mixtures of two or more of these compounds.

The mineral oils (A) may more particularly be fuel oils, mineral sealing oils, naphthenic oils and paraffinic oils.

Vegetable oils (B) (plant oils) are fats and fatty oils that are obtained from oil plants. Starting materials for producing vegetable oil are oil seeds and oil fruits, in which the oil is present in the form of lipids. Plant oils and plant fats are primarily esters of glycerol with fatty acids, known as triglycerides. The delimitation relative to plant fats is the fluidity at room temperature. The essential oils, which are likewise obtained from plants, are not vegetable oils. In contrast to vegetable oils, they do not leave behind any grease spots on paper on drying. Vegetable oils include, for example, sunflower oil, rapeseed oil, safflower oil, soya oil, maize kernel oil, peanut oil, olive oil, cottonseed oil, palm oil, palm kernel fat and coconut fat.

The silicone oils (C) may be linear or branched polysiloxanes which possess methyl and/or hydroxyl end groups and preferably have a Brookfield viscosity>50 mPas, with particular preference a viscosity between 100 mPas and 10 000 mPas.

The polyoxyalkylenes (D) may have the general form (D-1):

R¹—{[(C₂H_{4-d}R′_{d}Oₙ(CₓH₂ₓO)ᵣ(C₂H_{4-d}R″_{d}Oₜ]—R²}_{z} (D-1)

where
R¹ corresponds to the radical of an alcohol, polyetherol or phenol R¹—H (the H belongs to the OH group of the alcohol or phenol). R¹—H preferably comprises monohydric or polyhydric polyether alcohols or alcohols having molar masses of preferably 32 to 2000 g/mol and 1 to 8, preferably 1 to 4, hydroxyl groups. Examples include allyl alcohol, butanol, octanol, dodecanol, stearyl alcohol, 2-ethylhexanol, cyclohexanol, benzyl alcohol, ethylene glycol, propylene glycol, di-, tri- and polyethylene glycol, 1,2-propylene glycol, di- and polypropylene glycol, 1,4-butanediol, 1,6-hexanediol, trimethylolpropane, glycerol, pentaerythritol, sorbitol, or hydroxyl-bearing compounds based on natural substances.

### Additionally

d is 1 to 3,
n is greater than or equal to 0,
x is 2 to 10, preferably 2.5 to 4,
r is greater than or equal to 0, preferably 5 to 350,
t is greater than or equal to 0,
n+r+t≧1,
z is 1 to 8, preferably 1 to 4, more preferably 1 and 2, and
R′ is a monovalent aromatic, optionally substituted hydrocarbon radical,
R″ is a hydrogen radical or a monovalent hydrocarbon radical having 1 to 18 carbon atoms, and
R² is an H atom, a monovalent organic linear or branched alkyl radical with a chain length of C₁-C₄₀, or a carboxyl radical of an optionally branched alkyl or aryl ester.

The compounds may be present either as pure substances or else in a statistical mixture with one another, in which case the numerical values indicated in the formulae correspond to the average of the statistical distribution of the value of the indices.

Suitable polysiloxanes (P) are described in DE 10 353856 and DE 28 29906, for example, whose disclosure content directed to the disclosed structures is hereby, in its entirety, made part of the present disclosure content. They may have the following structure (P-I)

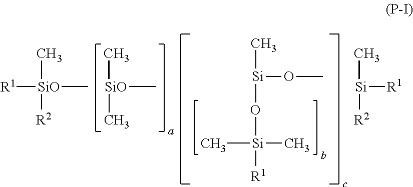

in which
R¹ may be identical or different in the average molecule and corresponds to a hydrocarbon radical having 1 to 14 carbon atoms, that optionally contains double bonds and may be —OH-functional, or to a radical —O—R* where R* is an alkyl radical having 1, 2, 3 or 4 carbon atoms, or to the radical —Z—(CₙH₂ₙ—O)ₘR′, where
R′ is a hydrogen radical or an alkyl radical having 1 to 8 carbon atoms, or acyl,
R² is phenyl, ethyl, methyl, hydroxyl, amine, with at least 90% methyl,
Z is a divalent radical of formula —O—, —NH—, —NR³— with R³=C₁₋₄ alkyl radical, —S—, —(CH₂)ₚ—O— or —CH₂—CH(CH₃)—CH₂—O— with p=2, 3 or 4,
n has an average numerical value of greater than 2.5 to 4.0,
m has an average numerical value of 5 to 350,
a has an average numerical value of 4 to 1500,
b has an average numerical value of 0 to 100,
c has an average numerical value of 0 to 100.
   Suitable modified polysiloxanes (P) may also be structures of the formula (P-II)

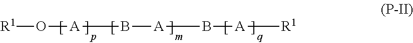

where the indices have the following definitions:
m has a value from 2 to 100,
p has a value of 0 or 1 and
q has a value of 0 or 1,
   and where the radicals (R¹, A, B) have the following definitions,
   R¹ is an H atom, a monovalent organic linear or branched alkyl radical with a chain length of C₁-C₄₀, or a carboxyl radical of an optionally branched alkyl or aryl ester,
   A is a polyoxyalkylene block of the average formula (P-IIa)

[(C₂H_{4-d}R′_{d}O)ₙ(CₓH₂ₓO)ᵣ(C₂H_{4-d}R″_{d}O)ₜ] (P-IIa)

where
d is 1 to 3,
n is greater than or equal to 0,
x is 2 to 10,
r is greater than or equal to 0,
t is greater than or equal to 0,
n+r+t≧1, and
R′ is a monovalent aromatic, optionally substituted hydrocarbon radical, and
R″ is a hydrogen radical or a monovalent hydrocarbon radical having 1 to 18 C atoms,
   B is a polysiloxane block of the average formula (P-IIb)

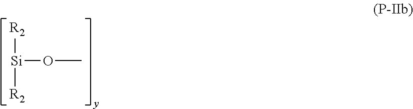

where
R² is identical or different at each occurrence and comprises an alkyl radical having 1 to 4 carbon atoms, or a phenyl radical, and
y has a value from 5 to 200.
   Suitable modified polysiloxanes (P) may also be structures of the formula (P-III)

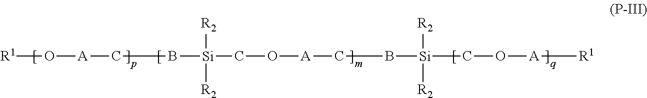

where the radicals R¹, A, and B and indices m, p and q have the above-designated definitions as in formula (P-II),
the radical R² has the definition as in formula (P-IIb), and
C is a linear or branched alkylene radical having 2 to 20 carbon atoms.

The compounds may be present as pure substances or else in a statistical mixture with one another, with the numerical values indicated in the formulae corresponding to the average value of the statistical distribution of the value of the indices.

As compound E it is preferred to use a polyetherpolysiloxane of the formula (E-I)

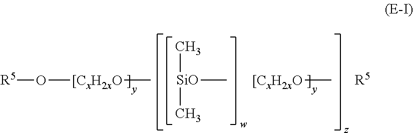

where R⁵ in the average molecule may be identical or different and corresponds to an alkyl radical having 1 to 8 carbon atoms, preferably methyl, ethyl, n- or iso-propyl or n-, sec- or tert-butyl, but at least 90% of the radicals R⁵ are methyl radicals,
x has an average numerical value of 2.6 to 3.0, preferably, 2.8-3.0,
y has an average numerical value of 8 to 80, preferably 8-40,
w has an average numerical value of 7 to 50, preferably 7-25,
z has an average numerical value of 1.5 to 10, preferably 1.5-5.

The polyether fraction of the compound E according to formula (E-I) is indicated by y. These polyethers are obtained by methods familiar to the skilled person, from the reaction of alkylene oxides in a ring-opening polymerization, started with alcohols having the radical R⁵. More preferably the alkylene oxides are reacted under basic conditions to give the corresponding polyethers. The polyethers are prepared preferably by reaction of a starting alcohol with ethylene oxide and/or propylene oxide. The polymerization of the alkylene oxides may be carried out alone or in any desired mixtures. The sequence of the addition-reaction steps may be arbitrary, and so, depending on the procedure, unsaturated polyethers of random, block or gradient construction are obtained.

As alkylene oxides it is possible, generally, to use all of the alkylene oxides that are known to the skilled person, alone or in any desired mixtures. With preference it is possible to use ethylene oxide, propylene oxide, 1,2-butylene oxide, 2,3-butylene oxide, isobutylene oxide, oct-1-ene oxide, dec-1-ene oxide, dodec-1-ene oxide, tetradec-1-ene oxide, hexadec-1-ene oxide, octadec-1-ene oxide, □-pinene epoxide, cyclohexene oxide, 3-perfluoroalkyl-1,2-epoxypropane and styrene oxide. Particular preference is given to using ethylene oxide, propylene oxide, dodec-1-ene oxide and styrene oxide. Ethylene oxide and/or propylene oxide are/is used with very particular preference.

The aforementioned compounds also may be present bound on suitable carrier materials, and may thus form hydrophobized solids. The solids used for this purpose include, for example, silica (F), aluminium oxide, alkaline earth metal carbonates, or similar and customary finely divided solids known from the prior art. Organic hydrophobic substances are alkaline earth metal salts of long-chain fatty acids having 12 to 22 carbon atoms, which are known for this purpose, the amides of such fatty acids, polyureas (G) and waxes (H), and also mixtures of these solids.

Examplary urea derivatives (G) are described in DE 3245482 and DE 19917186. DE 19917186 indicates the general formula (G-1):

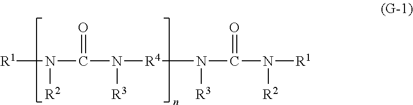

where
R¹ is a hydrocarbon radical having 4 to 30 carbon atoms or a hydrocarbon radical having 4 to 24 carbon atoms and a nitrogen atom, or a hydrocarbon radical having 4 to 30 carbon atoms and a carbonyl group,
R² is a hydrogen atom or a hydrocarbon radical having 1 to 24 carbon atoms,
R³is a hydrogen atom or a hydrocarbon radical having 1 to 24 carbon atoms,
R⁴is an organic radical having 2 to 30 carbon atoms, and
n is 0 to 5.

Examples of the waxes (H) are polyethylene waxes, polyamide waxes or mixtures thereof, having a melting point or softening point above the application temperature, preferably at an ambient temperature of 25° C.

Compounds N for the purposes of this invention are surface-active substances, which may belong to the classes of nonionic. cationic, anionic or amphoteric surfactants, and also gemini surfactants.

In the formulae below, for the explanation of the compounds N, the radical P denotes:

—(CH₂—)_{g}(OC₂H₄—)ₕ(OC₃H₆—)ᵢ(OC₄H₈)ⱼ(OCH₂CH(C₆H₅))ₖOR²⁰

where
R²⁰ is a hydrogen, alkyl or carboxyl radical. Preferably R²⁰ is a hydrogen or methyl radical or acetyl radical,
and the indices
g is a number from 0 to 6, preferably from 0 to 3,
h is a number from 0 to 20, preferably from 5 to 80,
i is a number from 0 to 50, preferably from 0 to 30, with h+i≧1,
j is a number from 0 to 10, preferably<5, more particularly 0, and
k is a number from 0 to 10, preferably<5, more particularly 0.

In the formulae below, for the explanation of the compounds N, the radical R²¹ corresponds to

hydrogen or a linear or branched, optionally unsaturated alkyl radical having 1-25 carbon atoms, examples being methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, triacontyl, phenylmethyl (benzyl), diphenylmethyl, triphenylmethyl, 2-phenylethyl, 3-phenylpropyl, cyclopentylmethyl, 2-cyclopentylethyl, 3-cyclo-pentylpropyl, cyclohexylmethyl, 2-cyclohexylethyl, 3-cyclohexylpropyl, allyl, undecaenyl, dodecaenyl, octadecaenyl, eicosaenyl, docosaenyl, tetracosaenyl, octadecadienyl, octadecatrienyl, eicosatetraenyl, eicosapentaenyl, docosapentaenyl or docosahexaenyl.

### 1 Nonionic Organic Surfactants:

alkylamine alkoxylates, e.g. polyethylene glycol cocosamine (traded as VARONIC K-205) or polyethylene glycol stearylamine (traded as Varonic S), of the general formula

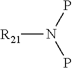

amidoamines, e.g. stearylamidopropyldimethylamine, of the general formula

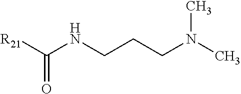

alkanolamides, e.g. diethanolamides (traded under the names REWOMID DC212S or REWOMID S280) of the general formula

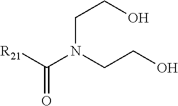

alkyl-N-glucamides, e.g. octyl-N-glucamide (traded under the name MEGA-10)
alkylglucosides, e.g. n-nonyl-β-D-glucopyranoside or octyl-β-D-thiogluco-pyranoside (traded under the range name AGNIQUE PG)
alkyl alkoxylates or fatty alcohol alkoxylates, e.g. polyethylene glycol p-(1,1,3,3-tetramethylbutyl)phenyl ether (traded under the name TRITON X-100) or polyethylene glycol isotridecyl ether (traded under the name TEGO Alkanol TD 6) or polyethylene glycol stearyl ether (traded under the names TEGO Alkanol S 2, S 10 ROH, S 20P) or polyethylene glycol oleyl ether (traded under the name TEGO Alkanol O 20) or polypropylene glycol myristyl ether (traded under the name VARONIC APM) or polyethylene glycol nonylphenyl ether or polyethylene glycol polypropylene glycol copolymers (traded under the PLURONIC names, e.g. F68 or F127) of the general formula

R₂₁—P
polyether polyols (traded, for example, under the names TERGITOL L-62 E and L-62 and L-81)
sorbitan esters, e.g. sorbitan monolaurate (traded under the name TEGO SML) or sorbitan trioleate (traded under the name TEGO STO), of the general formula

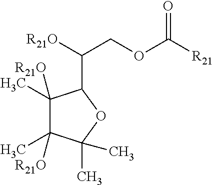

sorbitan ester ethoxylates, e.g. polyoxyethylenesorbitan monolaurate (traded under the name TEGO SML 20) or polyethylene glycol monooleate (traded under the name TEGO SMO) or polyethylene glycol sorbitan tristearate (traded under the name TEGO STS)
fatty alcohols, e.g. isostearyl alcohol (traded under the name TEGO Alkanol 66) or oleyl alcohol (traded under the name TEGO Alkanol 80, 85 and 90) of the general formula

R₂₁—OH
fatty acid ethoxylates, e.g. polyethylene glycol stearate (traded under the name TEGO Acid S) or polyethylene glycol oleate (traded under the name AROSURF 8-190 or REWOPAL EO 70) of the general formula

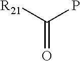

neutralized polyether phosphates (e.g. traded under the name TEGO Dispers 651)
ester ethoxylates, e.g. polyethylene glycol glyceryl laurate (traded under the name TAGAT L2) or polyethylene glycol glyceryl oleoricinoleate (traded under the name TAGAT V20) or polyethylene glycol glyceryl cocoate (traded under the name Varonic L1)
organomodified siloxanes, for example: polyethersiloxanes, e.g. traded under the range name TEGOPREN or the range name TEGO WET.

Particularly suitable polyethersiloxane derivatives are those of the following general formula (XVIII):

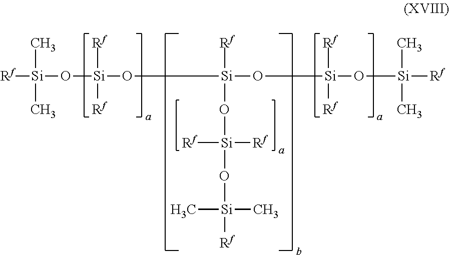

where the radical
R^{f} may be the radical R¹, where
R¹ is an alkyl radical having 1 to 4 carbon atoms, or an aryl radical, or
R^{f} is the radical R² or R³, with the proviso that at least one radical R^{f} is the radical R², where
R² and R³ independently of one another are polyether radicals of the formula (XIX)

F_{q}[O(C₂H_{4-d}R′_{d}O)ₘ(CₓH₂ₓO)ᵣZ]_{w} (XIX)

with the definitions
d is 1 to 3
m is >1
q is 0 or 1
x is 2 to 10
r is >1
w is 1 to 4
F is a hydrocarbon radical, which may also be branched,
R′ is a hydrogen radical or a monovalent hydrocarbon radical having 1 to 18 C atoms
Z is an H atom or a monovalent organic radical such as alkyl or alkyl ester or aryl ester,
   and where in formula (XVIII)
   b is a number from 0 to 8,
   a is a number from 1 to 100, if b is a number from 6 to 8,
   a is a number from 1 to 200, if b is a number from 3 to 6,
   a is a number from 1 to 300, if b is a number from 0 to 3.

The values of a and b are to be understood as average values, since the silicone polyether copolymers used in accordance with the invention are present in the form of regularly equilibrated mixtures.

The radicals R¹ (in formula XVIII) are alkyl radicals having 1 to 4 carbon atoms, such as methyl, ethyl, propyl or butyl radicals, or aryl radicals, with the phenyl radicals being preferred. On the basis of preparation and price, the methyl radicals are preferred, and so at least 80% of the radicals R¹ are methyl radicals. Particularly preferred polysiloxanes are those in which all of the radicals R¹ are methyl radicals. The siloxane mixture may be straight-chain (b=0) or branched (b>0 to 8). From experience, the value of a can be combined with values of b only in the manner stated, since otherwise the increased viscosity makes handling impossible.

Particularly preferred silicone polyether copolymers are those of the general formula (XX)

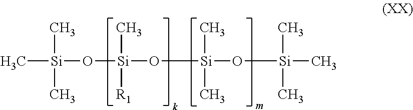

in which
m=0 to 30,
k=1 to 5,
R¹ is an allyl alcohol or a polyether which is prepared starting from alkyl and is reacted with 1 to 10 ethylene oxide molecules and between 1 and 25 propylene oxide molecules.
functionalized polyethersiloxanes, e.g. traded under the product name TEGOPREN 7100
polyethersiloxanes of blockwise construction.
   Suitable polyethersiloxanes of blockwise construction are structures of the formulae (XXI) or (XXVI)

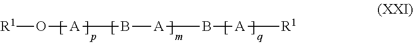

where the indices have the following definitions:
m is a value from 2 to 100,
p is a value of 0 or 1 and
q is a value of 0 or 1,
   and where the radicals (R¹, A, B) have the following definitions:
   R¹ is an H atom, a monovalent organic linear or branched alkyl radical with a chain length of C₁-C₄₀, or a carboxyl radical of an optionally branched alkyl or aryl ester,
   A is a polyoxyalkylene block of the average formula (XXII),

[(C₂H_{4-d}R′_{d}O)ₙ(CₓH₂ₓO)ᵣ(C₂H_{4-d}R″_{d}O)ₜ] (XXII)

where
d is 1 to 3,
n is greater than or equal to 0,
x is 2 to 10,
r is greater than or equal to 0,
t is greater than or equal to 0,
n+r+t≧1, and
R′ is a monovalent aromatic, optionally substituted hydrocarbon radical, and
R″ is a hydrogen radical or a monovalent hydrocarbon radical having 1 to 18 C atoms,
   B is a polysiloxane block of the average formula (XXIII),

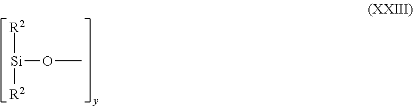

where
R² is identical or different at each occurrence and comprises an alkyl radical having 1 to 4 carbon atoms, or a phenyl radical, and
y has a value of 5 to 200;
   formula (XXVI)

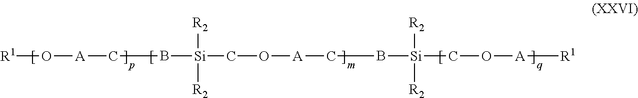

where the radicals R¹, A and B and indices m, p and q have the above-designated definition as in formula (XXI),
the radical R² has the definition as in formula (XXIII), and
C is a linear or branched alkylene radical having 2 to 20 carbon atoms.

### 2 Cationic Surfactants:

esterquats, e.g. available commercially under the names REWOQUAT WE 15, VARISOFT WE 16 or REWOQUAT WE 38 DPG, of the general formula

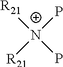

with R²⁰=acetyl
diamidoamine quats, e.g. available commercially under the names VARISOFT 110-75[N,N-bis(hydrotallowamidoethyl)-N-polyethoxy-N-methyl-ammonium methylsulphate], VARISOFT 222 LT-90 [N,N-bis(oleylamidoethyl)-N-polyethoxy-N-methylammonium methylsulphate], or REWOQUAT WE 38 DPG or VARIQUAT 238-90 [N,N-bis(tallowamidoethyl)-N-polypropoxy-N-methylammonium methylsulphate], of the general formula

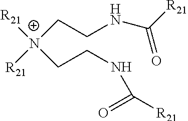

alkoxyalkyl quats, e.g. available commercially under the name VARIQUAT 638 [N-methyl-N,N-bis(2-hydroxyethyl)-N-cocosammonium chloride]
benzylquats, e.g. available commercially under the names VARIQUAT 80 MC [dimethylalkyl(C₁₂-C₁₆)benzylammonium chloride] and VARIQUAT SDAC [dimethylstearylbenzylammonium chloride], of the general formula

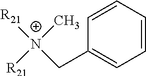

silicone quats, e.g. available commercially under the names TEGO PR EN 6921 [diquaternary polydimethylsiloxane], TEGOPREN 6924 [diquaternary polydimethylsiloxane], TEGOPREN 6925 [diquaternary polydimethylsiloxane], TEGOPREN 6930 [organomodified polydimethylsiloxane preparation] and TEGOPREN 7990 [diquaternary polyetherpolydimethylsiloxane].

### 3 Amphoteric Surfactants:

betaines of the general formula (II), such as, for example, 3-[N,N-dimethyl(3-myristoylaminopropyl)ammonio]propanesulphonate (available commercially under the name Amidosulfobetaine-14) or 1-(3-sulphopropyl)pyridinium betaine or 3-dodecyldimethylammoniopropane-1-sulphonate (available commercially under the name ZWITTERGENT 3-12) or 3-[(3-cholamidopropyl)dimethylammonio]-1-propansulphonate (traded under the name CHAPS) or laurylbetaine (traded under the name REWOTERIC AM DML-35) or cocamidopropyl betaine (traded under the name TEGO Beta in F 50 or L 7)
alkylglycines, e.g. n-dodecyl-N,N-dimethylglycine (traded under the name EMPIGEN BB) or tallowglycine (traded under the name REWOTERIC AM TEG), of the general formula

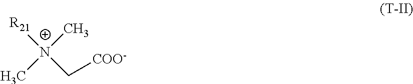

sultaines, e.g. cocamidopropylhydroxysultaine (traded under the name REWOTERIC AM CAS), of the general formula

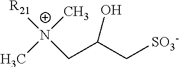

amphopropionates, e.g. cocoamphopropionate (traded under the name REWOTERIC AM KSF 40), of the general formula

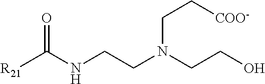

amphoacetates, e.g. sodium cocoamphoacetate (traded under the name REWOTERIC AM C), of the general formula

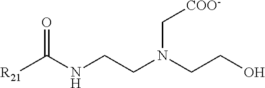

amine oxides, e.g. cocamidopropyldimethylamine oxide (traded under the name VAROX 1770), of the general formula

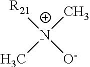

silicone betaines, e.g. traded under the name TEGOPREN 6950.

### 4 Anionic Surfactants:

Anionic emulsifiers comprise anionic groups which confer solubility in water, such as a carboxylate, sulphate, sulphonate or phosphate group, for example, and a lipophilic radical. Anionic surfactants are known to the skilled person in large numbers and are available commercially. They include more particularly alkyl sulphates or alkyl phosphates in the form of their alkali metal salts, ammonium salts or alkanolammonium salts, alkyl ether sulphates, alkyl ether carboxylates, acylsarcosinates and also sulphosuccinates and acylglutamates in the form of their alkali metal salts or ammonium salts. Use may also be made of dialkyl and trialkyl phosphates and also mono-, di- and/or tri-PEG-alkyl phosphates and the salts thereof. It is likewise possible to employ maleic anhydride copolymers.

### 5 Gemini Surfactants:

acetylenediols, e.g. traded under the name SURFYNOL 104
acetylenediol alkoxylates, e.g. traded under the names SURFYNOL 400 or SURFYNOL 2502
acetylene glycols, e.g. traded under the name DYNOL 604
alkanediols, alkanedicarboxylic acids and the esters thereof, e.g. traded under the names ENVIROGEM AD01, ENVIROGEM AE01, ENVIROGEM AE02 and ENVIROGEM AE03.
siloxane-based gemini surfactants, as described in EP1382632A1, e.g. traded under the name TEGO TWIN 4000. The content of EP1382632A1 is considered in its entirety to form part of the present disclosure content.

The compositions of the invention preferably comprise, as a performance additive, one or more nonionic surfactants, more preferably one or more organomodified siloxanes, more preferably one or more polyethersiloxanes and more particularly polyethersiloxanes of the formula (XVIII).

The compositions of the invention preferably comprise nonionic or amphoteric surfactants, preferably one or more alkoxylates and/or betaines, more preferably one or more betaines, more particularly betaines of the formula (T-II), especially cocoamidopropyl betaines of the formula (T-II).

Quoted trade names are trade marks of the following companies:

TEGO, TEGOSURF, AROSURF, REWOQUAT, VARONIC, ADOGEN, REWOMID, VARAMID, REWOCOROS, REWOPAL, TAGAT, TEGO WET, TEGOPREN, VARISOFT, VARIQUAT and REWOTERIC are trade marks of Evonik Industries AG.
SURFYNOL, DYNOL and ENVIROGEM are trade marks of Air Products, Inc. AGNIQUE is a trade mark of Cognis
TRITON and TERGITOL are trade marks of DOW Chemical Company
GENAPOL is a trade mark of Clariant
PLURONIC is a trade mark of BASF AG
EMPIGEN is a trade mark of Albright&Wilson
VAROX is a trade mark of R.T. Vanderbilt
ZWITTERGENT is a trade mark of Calbiochem-Novachem.

The abovementioned compounds N may be used alone or in any desired mixtures with one another. Further customary solvents, adjuvants and additives may likewise be present or admixed.

Additional subject matter of the invention is characterized by the claims.

The compositions of the invention and their use are described exemplarily below, without any intention that the invention should be considered to be confined to these exemplary embodiments.

Where ranges, general formulae or classes of compound are indicated in this description, they are intended to encompass not only the corresponding ranges or groups of compounds that are explicitly stated, but also all sub-ranges and sub-groups of compounds which may be obtained by extracting individual values (ranges) or compounds. Where the present description cites documents, the intention is that their content should belong in whole to the disclosure content of the present invention. Where % figures are given below, these, unless otherwise specified, are figures in % by weight. In the case of compositions, unless otherwise specified, the % figures are based on the overall composition. Where average values are stated below, these are, unless otherwise stated, arithmetical average values (numerical averages). Where, below, measurement values are indicated, these measurement values, unless otherwise indicated, were determined under a pressure of 1013.25 hPa and at a temperature of 23° C.

The present invention is illustrated more closely with reference to FIGS. 1, 2 and 3, without any intention that the subject matter of the invention should be confined to these exemplary embodiments. The figures show height diagrams of the surfaces of the cured construction compounds along a line, the quality of which was determined using method 3 as described in the examples.

On the basis of visual examinations by means of the practised eye, or with the assistance of a microscope, the surfaces of the cured and dried construction compounds are evaluated. On the basis of the number, shape and testing of the superficial unevennesses, with craters, dimples or so-called pin-holes, it is possible to evaluate the quality of the surface and hence also the quality and grade of the construction compound.

With the aid of a Leica® DMRE microscope with a Leica® TCSE scanner, the qualitative assessment can be expanded by a quantitative statement. By means of a surface scan by the scanner, it is possible to determine the number of deviations, and the magnitude of the deviation, in the surface smoothness, in millimetres or fractions thereof. In this way, multiply, measurement fields were defined per 1 cm² of surface area, and 100 measurement scans were carried out per 1 cm.

### BRIEF DESCRIPTION OF THE DRAWINGS

FIG. 1 shows the cross section (determined using a Leica® DMRE microscope with a Leica® TCSE scanner) through a surface of a dried SLU, which was assessed by method 3 as a poor surface with a large number of craters, with a grading of 3.

FIG. 2 shows the cross section (determined using a Leica® DMRE microscope with a Leica® TCSE scanner) through a surface of a dried SLU, which was assessed by method 3 as a moderately good surface with few craters, with a grading of 2.

FIG. 3 shows the cross section (determined using a Leica® DMRE microscope with a Leica® TCSE scanner) through a surface of a dried SLU, which was assessed by method 3 as a good surface with few craters or none at all, with a grading of 1.

The subject matter of the present invention is elucidated in more detail below, using examples, without any intention that the subject matter of the invention should be confined to these exemplary embodiments.

### OPERATIVE EXAMPLES

### Example 1: Preparation of an SLU (Self-Levelling Underlayment) as an Example of a Construction Compound

The SLUs for testing were prepared using the components indicated in Table 1, with the constitution of the inventive composition employed being varied as indicated in Table 2.

The pulverulent components of the SLUs to be prepared and tested were weighed out into the stirring pot of a Hobart mixer. The pot was attached to the Hobart mixer and secured. In order to reduce dust, a moist nonwoven cloth was placed on the protective grid. The dry mixture was mixed for two minutes at a stirrer setting of 1. The required amount of water was incorporated during one minute at the same stirrer setting (setting 1). The stirrer setting was then increased.

The stirrer was removed from the mount, and the sediment formed was briefly redispersed by manual stirring. The stirrer was attached again and the stirrer setting was increased to setting 2. The stirrer was switched on again and the mixture was mixed for two minutes.

The mixture thus obtained is used within 1 to 10 minutes for determining the air content and the slump. The tests are notable for high repeatability.

After the curing and drying of the construction compound, the surface quality is assessed.

### Determination of Air Content Slump and Surface Quality:

### Method 1: Determination of the Pore Volume by DIN 18555 Part 2

The complete SLU was placed in the container of an air content tester (testing type, serial number 2558, manufacturer tecnotest, IT) for determining the pore volume, from the company Form+Test®, and spread smoothly; the remainder was kept for the determination of the slump. The upper part of the instrument was then placed on, and the instrument was closed and filled with distilled water to the overflow point. Air was then pumped into the top part of the container, and the pressure was set so that the pointer of the scale stood at the zero mark. The system was let down via a valve and the air content (in %) was read off on the display.

### Method 2: Determination of the Slump on the Matrix Board by DIN 18555 Part 2

The remainder of the SLU mixture was introduced into a test sleeve 30 mm in diameter and 50 mm long, and placed on the horizontally oriented laboratory bench. Beneath the test sleeve there was an untreated PE film. The filled test sleeve was raised to a height of approximately 5 cm for 15 seconds and then finally (without dripping) removed from the bench. After 60 and 90 seconds, a ruler was used to determine the slump, which was recorded. The slump here corresponds to the average value of the two diameters, measured along the half-radii of the circular or elliptical propagation of the construction compound.

### Method 3: Assessment of the Dried SLU Surface

After a drying time of 24 hours, the surface of the dried SLU obtained by method 2 was subjected to visual assessment. The surface in this case was assessed according to the number of craters, i.e. surface defects, such as “pin-holes”, for example, which have formed during the drying process of the SLU. Evaluation was made in accordance with the following scheme: no craters (0-1/cm²), few craters (2-10/cm²), numerous craters (>10/cm²). The surface quality was additionally evaluated using a microscope (e.g. confocal laser scanning microscope). A deviation from a planar surface of at least 0.05 mm was considered to constitute a surface defect. In borderline cases, the overall impression was employed for assessment.

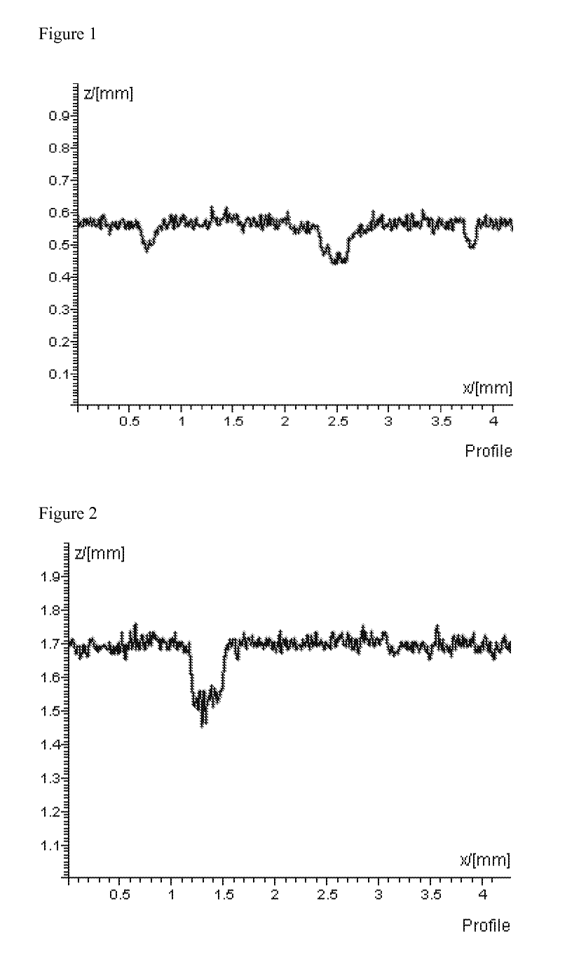

FIGS. 1 to 3, produced using microscopy, can be used as examples of the surface quality evaluation.

The parameter z is used as a measure of the surface. Craters are considered to be deviations of z from the average value of z (transverse) of greater than or equal to 0.05 mm.

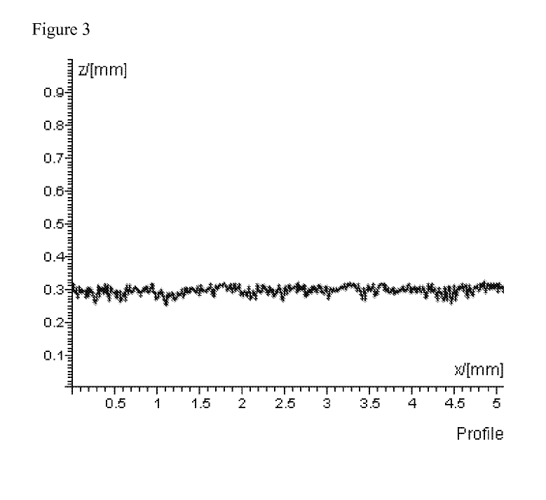

Accordingly, three craters are shown in FIG. 1, one crater in FIG. 2, and no craters in FIG. 3.

TABLE 1
Constitution of the inventive and comparative SLUs prepared

| Constituents | inventive | | comparative | |
|---|---|---|---|---|
| Portland cement | 185 | g | 185 | g |
| Alumina cement | 115 | g | 115 | g |
| CaSO₄ hemihydrate | 65 | g | 65 | g |
| Silica sand | 406.7 | g | 406.7 | g |
| Finely ground limestone | 194 | g | 194 | g |
| Redispersible powder (Vinnapas ® 5023 | 20 | g | 20 | g |
| L-Wacker AG) | | | | |
| Li₂CO₃ | 1 | g | 1 | g |
| Inventive composition carried on flyash | 1.5 | g | — | |
| (mixture of a compound E in the form of a | | | | |
| polyetherpolysiloxane as per formula (E-I) | | | | |
| and a compound N in the form of a betaine | | | | |
| as per formula (II) - mixing ratio as per | | | | |
| Table 2) | | | | |
| Citric acid | 1.7 | g | 1.7 | g |
| Shrinkage reducer (TEGO ® Sitren ® PSR | 6.5 | g | 6.5 | g |
| 100) | | | | |
| Superplasticizer (Melflux ® 2651F - BASF | 2.5 | g | 2.5 | g |
| SE) | | | | |
| Stabilizer (Starvis ® 3003F - BASF SE) | 1.1 | g | 1.1 | g |
| Interim total | 1000 | g | 998.5 | g |
| Water | 213.6 | g | 213.6 | g |
| Total | 1213.6 | g | 1212.1 | g |

TABLE 2
Mass ratios used of defoamer to wetting agent, and results of the tests by methods 1 to 3

| | Blank value | | | | | | | | | |
|---|---|---|---|---|---|---|---|---|---|---|
| | (without | only | | | | | | | | |
| Ratio of | compound N | E, | | | | | | | | only |
| compound E to | and without | no | | | | | | | | N, |
| compound N | compound E) | N | 18:1 | 9:1 | 6:1 | 4.5:1 | 3:1 | 1.8:1 | 0.9:1 | no E |
| Evaluation of | 3 | 3 | 3 | 2 | 1 | 1 | 2 | 2 | 3 | 3 |
| surface quality | | | | | | | | | | |
| Air content [%] | 12.1 | 7.4 | 9.3 | 10.1 | 9.5 | 12.1 | 13.6 | 16.5 | 18.2 | 26.7 |
| Slump after 60 s | 129 | 137 | 137 | 135 | 136 | 131 | 129 | 129 | 130 | 130 |
| [mm] | | | | | | | | | | |
| Slump after 90 s | 131 | 139 | 139 | 137 | 138 | 133 | 131 | 131 | 132 | 132 |
| [mm] | | | | | | | | | | |

As can be seen from the results listed in Table 2, the properties of the self-levelling underlayment are set optimally in relation to surface quality, air content and slump for blends with a mass ratio of compound E to compound N of 6:1.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A composition comprising a mixture containing
a) at least one component which comprises a compound N which exhibits wetting activity in aqueous cementitious binder systems and
b) at least one component which comprises a compound E which exhibits defoaming properties in aqueous cementitious binder systems, the compound E being different from the compound N and
the mass ratio of compound N to compound E being from 0.001:1 to 1000:1.

2. The composition according to claim 1, wherein the composition is present as a solid at a temperature of 25° C.

3. The composition according to claim 1, wherein at least one of compound N of component a) and compound E of component b) are present as a solid at a temperature of 25° C.

4. The composition according to claim 1, wherein component a) and/or component b) consist/consists exclusively of the respective compound N or of the respective compound E.

5. The composition according to claim 1, wherein component a) and/or component b) comprise/comprises the compound N or the compound E in applied or carried, absorbed, encapsulated or adsorbed form on or mixed with a carrier material.

6. The composition according to claim 5, wherein the carrier material is selected from inorganic or organic materials or mixtures thereof.

7. The composition according to claim 5, wherein the mass fraction of the compounds N or of the compounds E, based on the sum of the masses of the compounds N and/or compounds E and of the carrier materials in the respective components a) and/or b), is from 0.001% to 50% by weight.

8. The composition according to claim 1, wherein at least one compound N in component a) is a nonionic or amphoteric surfactant.

9. The composition according to claim 1, wherein at least one compound E in component b) is a polyetherpolysiloxane and the polyetherpolysiloxane is applied on a carrier material.

10. The composition according to claim 1, wherein component a) is a betaine present as a solid at a temperature of 25° C., component b) consists of a polyetherpolysiloxane applied to flyash as carrier material, in that the fraction of the compound E in component b) is from 1% to 10%) by weight, and the mass ratio of component a) to component b) is from 1:10 000 to 1:1.

11. The composition according to claim 1, wherein the composition, besides the mixture containing components a) and b), comprises further additions, and the mass fraction of the sum of components a) and b) is from 0.001% to 10% by weight based on the mass of the overall composition.

12. The composition according to claim 1, wherein the composition, in addition to the mixture containing components a) and b), comprises further additions, the further additions being selected from:
water;
binding agents or binders, including portland cement and/or alumina cement;
fillers, including calcium sulphate, its hydrates, silica sand, and/or finely ground limestone;
additives, including redispersible powders;
setting accelerators, including Li₂CO;
setting retarders, including citric acid;
shrinkage reducers;
plasticizers, and
superplasticizers.

13. The composition according to claim 1, wherein the composition, besides the mixture containing components a) and b), further comprises additions selected from the group consisting of portland cement, gypsum, cement, alumina cement or mixtures thereof.

14. The composition according to claim 1, wherein the composition is a construction compound.

15. A method for producing a construction compound, wherein the composition according to claim 1 is mixed with water and binders, and optionally one or more further additions, selected from: fillers, including calcium sulphate, its hydrates, silica sand and/or finely ground limestone;
additives, including redispersible powders;
setting accelerators, including lithium carbonate;
setting retarders, including citric acid;
shrinkage reducers;
plasticizers; and
superplasticizers.

16. A method comprising utilizing the composition according to claim 1 in construction compounds for producing floors which can be self-levelling.

17. The composition according to claim 1, wherein the mass ratio of compound N to compound E is from 0.01:1 to 100:1.

18. The composition according to claim 17, wherein the mass ratio of compound N to compound E is from 0.1:1 to 10:1.

19. The composition according to claim 18, wherein the mass ratio of compound N to compound E is from 0.15:1 to 7:1.

20. The composition according to claim 6, wherein the carrier material is selected from the group comprising silicas, aluminium oxide, sand, cement, flyash, bentonites, xonotlites, lime, starch, cellulose, wood granules or proteins and plastic pellets.

21. The composition according to claim 7, wherein the mass fraction of the compounds N or the compounds E based on the sum of the masses of the compounds N and/or the compounds E and of the carrier materials in the respective components a) and/or b) is from 0.01% to 30% by weight.

22. The composition according to claim 21, wherein the mass fraction of the compounds N or the compounds E based on the sum of the masses of the compounds N and/or the compounds E and of the carrier materials in the respective components a) and/or b) is from 0.% to 20% by weight.

23. The composition according to claim 22, wherein the mass fraction of the compounds N or the compounds E based on the sum of the masses of the compounds N and/or the compounds E and of the carrier materials in the respective components a) and/or b) is from 1% to 10% by weight.

24. The composition according to claim 8, wherein at least one compound N in component a) is an alkyl alkoxylate or a betaine.

25. The composition according to claim 24, wherein at least one compound N in component a) is a betaine which is present as a solid at a temperature if 25° C.

26. The composition according to claim 9, wherein the carrier material is an inorganic corner material including flyash.

27. The composition according to claim 10, wherein the mass ratio of component a) to component b) is from 1:1000 to 1:10.

28. The composition according to claim 27, wherein the mass ratio of component a) to component b) is from 1:500 to 1:20.

29. The composition according to claim 11, wherein the mass fraction of the sum of components a) and b) is from 0.01% to 5% by weight, based on the mass of the overall composition.

30. The composition according to claim 29, wherein the mass fraction of the sum of components a) and b) is from 0.05%) to 1% by weight, based on the mass of the overall composition.

31. The composition according to claim 14, wherein the construction compound is a self-levelling underlayment or a self-levelling flooring compound.

32. The method according to claim 15, wherein the binders include portland cement, alumia cement, or mixture thereof.

33. The composition according to claim 6, wherein the carrier material is an inorganic carrier material.
